(19) United States
(12) Patent Application Publication
(10) Pub. No.: US 2013/0060602 A1
(43) Pub. Date: Mar. 7, 2013

(54) SYSTEMS AND METHODS TO DETERMINE IMPACT OF TEST SUBJECTS

(71) Applicants: Heather Rupp, San Francisco, CA (US); W. Bryan Smith, San Francisco, CA (US)

(72) Inventors: Heather Rupp, San Francisco, CA (US); W. Bryan Smith, San Francisco, CA (US)

(21) Appl. No.: 13/464,591

(22) Filed: May 4, 2012

Related U.S. Application Data
(60) Provisional application No. 61/483,563, filed on May 6, 2011.
(60) Provisional application No. 61/482,308, filed on May 4, 2011.

(51) Int. Cl. G06Q 30/02

(52) U.S. Cl. 705/7.29

(57) ABSTRACT

Example systems and methods to determine the impact or effectiveness of a test subject on a panelist are disclosed herein. An example method involves obtaining first implicit response data from a panelist at a first time period before an interaction during which the panelist is exposed to a test subject, obtaining second implicit response data from the panelist at a second time period after the interaction, and determining an impact of the test subject on the panelist based on the first and second implicit response data.

### RELATED APPLICATION

This patent claims the benefit of U.S. Provisional Patent Application Ser. No. 61/482,308, entitled “Optimal Method for Combining Cognitive Function Assessment and Biosensory Information Market Research Applications,” which was filed on May 4, 2011, which is incorporated herein by reference in its entirety, and the benefit of U.S. Provisional Patent Application Ser. No. 61/483,563, entitled “Evaluation of Biometric and Implicit Cognitive Responses to Multi-Sensory Consumer Products Using Controlled Exposure,” which was filed on May 6, 2011, which is incorporated herein by reference in its entirety.

### FIELD OF THE DISCLOSURE

This disclosure relates generally to audience measurement, and, more particularly, to systems and methods to determine impact of test subjects.

### BACKGROUND

Traditional systems and methods for assessing the impact of advertising and other consumer-related stimuli, such as entertainment media, branding, product packaging, and/or other characteristics of products or service, are often limited and rely on extensive reviews of sales data.

### BRIEF DESCRIPTION OF THE DRAWINGS

FIG. 1 is a schematic illustration of an example system constructed in accordance with the teachings of this disclosure to determine an impact of a test subject on panelist(s).

FIG. 2 is a flowchart representative of example instructions that may be executed to determine an impact of a test subject on panelist(s) and/or, more generally, to implement the example system of FIG. 1.

FIG. 3 is a flowchart representative of other example instructions that may be executed to determine an impact of a test subject on panelist(s) over a period of time and/or, more generally, to implement the example system of FIG. 1.

FIG. 4 is a flowchart representative of example instructions to implement the controlled interaction of the example process of FIG. 3.

FIG. 5 is a flowchart representative of other example instructions that may be executed to determine an impact of a test subject on panelist(s), and/or, more generally, to implement the example system of FIG. 1.

FIG. 6 is a flowchart representative of other example instructions that may be executed to determine an impact of a test subject on panelist(s), and/or, more generally, to implement the example system of FIG. 1.

FIG. 7 is a flowchart representative of other example instructions that may be executed to determine an impact of a test subject panelist(s), and/or, more generally, to implement the example system of FIG. 1.

FIG. 8 is an example rating questionnaire that may be used in any of the example processes of FIGS. 2-7 and/or, more generally, used to collect the example survey data of FIG. 1.

FIG. 9 is a schematic illustration of an example processor system that may be used and/or programmed to execute the example instructions of FIG. 2-7 to implement the example apparatus of FIG. 1.

### DETAILED DESCRIPTION

Known assessments of the impact or effectiveness of audience exposure to various subjects of interest, such as, for example, media, content, advertising, entertainment, branding, logos, packaging, and/or a product itself, rely on behavior-based data and/or survey data collected from panelist(s) exposed to the stimuli. For example, behavior-based data may include data collected by measuring changes in sales of products or services following an advertising campaign. In other known examples, the panelist(s) exposed to advertising may be asked to complete surveys after exposure to determine the effect of the exposure or after a purchase to evaluate the contribution exposure to the advertising campaign made to the purchase. In other known examples, the panelist(s) may be asked to complete surveys after exposure to a product (e.g., after a purchase) to assess the preferences of the panelist(s) for the product and/or the effect of the product on their purchasing decisions. However, sales analysis in such known techniques requires many resources, a willingness and cooperation from companies to provide sensitive and confidential information and/or the probability that factors other than an advertising campaign (e.g., consumer needs, seasonal effects, etc.) contributed to the sales figures or a change therein. Also, survey results in such known techniques provide only limited and sometimes inaccurate information about the experience(s) of panelist(s).

In recent years, the market research industry has implemented psychological methodologies to measure and/or predict consumer behavior and/or responses based on both explicit and implicit cognitive measures. As used herein, explicit cognition refers to conscious and/or intentional mental processes that influence a person's behavior. Thus, explicit cognitive measures involve many traditional forms of market research including surveys, questionnaires, interviews, self-reporting, etc. In contrast, as used herein, implicit cognition refers to unconscious, non-intentional, and/or automatic mental processes that influence a person's behavior. In other words, while all people have different knowledge, perceptions, and memories that influence their actions, only when a person is aware of or can consciously recall the knowledge, perception, or memory is that influence explicit. Otherwise, the influence of the person's knowledge, perceptions, or memories is implicit. Accordingly, implicit psychological measures include tools that indirectly assess the non-declarative information processing and responses of panelist(s) to particular stimuli or test subject. Such responses are herein referred to as ‘implicit responses’ and/or ‘automatic responses’. Furthermore, the underlying behavior or attitude of panelist(s) that may be assessed based on collected implicit responses is herein referred to as their ‘implicit attitude’, ‘automatic attitude’, ‘implicit bias’, ‘automatic bias’, ‘attitude’ and/or ‘bias’.

In some examples, implicit responses may be more useful than explicit responses because implicit responses provide response data that panelist(s) may be unwilling or unable to provide, such as when panelist(s) are responding to very similar or sensitive brands, products, and/or other stimuli. While known applications of implicit measures in market research have been employed to assess implicit attitudes of panelist(s) at a particular point in time and/or during a particular context (e.g., panelist bias either before or after exposure to a test subject), examples disclosed herein use implicit measures to assess the change in implicit attitudes over time and/or the impact of a particular context, stimuli, and/or product use (e.g., product preference and/or brand affiliation) on that change. For example, implicit measures may be performed before exposure to the test subject (e.g., media, a product, a brand, and/or packaging), again after the exposure, and again at a later time. In this manner, the implicit measures provide a baseline measure of an initial or pre-exposure bias of the individual panelist(s) as well as the individual response sensitivities of the panelist(s) that serve as an individual control to compare to responses collected after exposure to the test subject. In particular, the pre-exposure bias of the panelist(s) may be compared to a post-exposure bias based on the data collected after the panelist(s) are exposed or interact with the test subject to determine a direct or short-term impact of the test subject on the panelist(s) and their implicit biases. Furthermore, a long-term or residual bias may be determined based on the implicit data collected at a later time to assess the lasting influence and/or behavioral relevance of the test subject on the panelist(s) and their attitudes in the long term. Such repeated use of implicit measures enables market researchers to identify changes in attitude toward brands and/or products even when there is no observable explicit change in the behavior of panelist(s).

In addition to the application of psychological methodologies regarding implicit attitudes, examples disclosed herein employ neuro-marketing, which integrates biosensory measurements (e.g., neurological and/or physiological measurements) into consumer evaluation procedures. Specifically, brain activity, heart activity, muscle activity, skin conductance, eye movement, and/or other neurological and/or physiological signals are measured before, during, and/or after consumer(s) are exposed to a test subject such as, for example, media, content, an advertisement, entertainment, a brand associated with the product or a service, a packaging associated with the product, the product itself, or any other consumer-related stimulus or other subject of interest. Accordingly, panelist(s) exposed to and/or interacting with the test subject include panelist(s) viewing, listening, reading, holding, tasting, smelling, using, and/or otherwise engaging with and/or perceiving the test subject. Such biosensory measurements are used in the examples disclosed herein to further enhance a determination of the impact of a test subject on panelist(s) as they collected data may be indicative of one or more of alertness, engagement, attention, memory, and/or resonance (e.g., the amount a test subject or instance of the test subject affects or resonates with a subject).

Typically, known research of audience exposure to media and/or other test subjects has been limited to auditory (e.g., a radio commercial), visual (e.g., a billboard) and/or combined audio-visual (e.g., a television commercial) sensory modalities. Test subjects based on other sensory modalities, including, for example, gustatory (e.g., taste), olfactory (e.g., smell), and/or somatosensory (e.g., touch, temperature, position, movement, pressure, etc.) stimuli are evaluated in accordance with the examples disclosed herein. Further, in some examples, the evaluated test subjects comprise multisensory stimuli that includes two or more of an auditory, a visual, a gustatory, an olfactory, and/or a somatosensory stimulus.

A test subject that provides multisensory stimuli present several obstacles to accurate measurement. For example, for panelist(s) to smell the test subject (e.g., a fragrant soap or other fragrant product of interest) typically necessitates the panelist(s) to either move towards the fragrant test subject or bring the fragrant test subject close to them. The same requirement of movement results for panelist(s) tasting (e.g., bringing to the mouth) and/or touching (e.g., lifting, stroking, pressing, etc.) the test subject. Such extra movement unrelated to the particular sensory stimulus of interest creates an artifact of additional sensory processing that increases noise or artifacts in brain signals of the panelist(s) monitored via electroencephalography (EEG) or other measurement method(s). Additionally, multisensory test subjects provide for greater variability in panelist interaction with the test subjects in contrast with the typical audio and/or visual subject matter due to individually directed action sequences and/or the duration of those action sequences. For example, if panelist(s) are presented with test subject (e.g., a product) they are to feel (e.g., touch), some panelists may pick up the test subject while others may simply place their hands on the test subject. Further, some panelists may use one hand and move little more than their arm, while others may use both hands and shift their bodies during the interaction. As a result, measurements received during such interactions may be non-uniform and complicate statistical analysis and comparison across panelists and/or extrapolation to larger populations. Examples disclosed herein overcome these obstacles.

As detailed herein, disclosed example methods and apparatus enable the evaluation of panelist responses to interactions with a test subject (e.g., media and/or product) involving multisensory stimuli. Some example methods disclosed herein involve performing calibration test(s) in the same sensory modalities as those to be measured with respect to the test subject to assess an individual panelist's response tendencies and determine baseline “marker” biometric patterns of favorable responses for comparison with the responses to the test subject. In this manner, panelist(s) provide the data to serve as their own individual control during the test subject interactions. Some example methods disclosed herein also include establishing controlled interactions comprising one or more timed phases of sequenced actions the panelist(s) are to perform. Controlling the timing and actions performed during the different phases of an interaction provides timing benchmarks to be used for data mapping. Furthermore, controlling the interactions in this manner enables the response data to be aggregated across the testing population while reducing signal noise.

Furthermore, some examples disclosed herein combine biometric measurement techniques of neuro-marketing and implicit measurement techniques of cognitive psychology, along with traditional marketing research (e.g., survey metrics) to enable market researchers to obtain a more complete picture of the overall impact of test subject on the panelist(s) across an entire experience.

Such a complete picture enables market researches to determine a variety of aspects of the impact of the test subject on the panelist(s). For example, as described above, a pre-exposure bias and a post-exposure bias may be compared to determine a change in the implicit attitude of the panelist(s) and whether it is a positive change or a negative change. Additionally, this change in implicit bias can be compared against one or more thresholds to determine a degree of change (e.g., whether the target subject had a high impact or a low impact on the panelist(s)). In some examples, the change in bias of individual panelist(s) may also be compared to the implicit bias of the panelist(s) measured at a later time period to determine whether the measured change or impact is permanent, whether the panelist(s) return to their initial pre-exposure bias, and/or whether the effect of the test subject on implicit attitudes fades overtime but leaves some residual change in bias and to what extent. Furthermore, in some examples, when panelist(s) are exposed to multiple test subjects in series with a determination of their implicit bias between each exposure, a change in bias resulting from each test subject may be determined as well as the progress of change over all exposures of the test subjects. In such examples, the determination of impact includes the level of priming effect one test subject has with respect to the others. Additionally, in some examples, any of these measured implicit attitudes and/or resulting changes in attitude may be compared with similar determinations for other panelists to determine the impact of the test subject(s) on more general populations.

Similar to the determination of impact based on implicit measures, various aspects of the impact of the test subject on panelist(s) can be determined based on biosensory measurements mentioned above and described in greater detail below. In some examples disclosed herein, biosensory measurements are used to measure how engaged, alert, and/or or attentive panelist(s) are during the test subject interaction as compared with baseline measurements taken before and/or after the interaction. Further, such measurements can be indicative of the panelist(s) resonance with respect to the test subject including, for example, whether the test subject arouses or excites the panelist(s), whether it they show a preference or an aversion towards the test subject, etc. Additionally, in some examples, the biosensory measurements are taken throughout the entire testing process thereby enabling the determination of an ongoing impact or effect of the test subject on the panelist(s), to identify if any particular point in the test subject interaction had a greater impact than others. As with the implicit measures, the biosensory measurements and resulting impact determinations may be compared across multiple panelists to compare the impact of a particular panelist relative to others and or estimate the impact of the test subject on a more general population.

Furthermore, the biosensory measurement data may be compared with and/or integrated with the implicit measurement data to gain further insights into impact of the test subject on the panelist(s). For example, the type(s) and/or level(s) of resonance and/or other biological or neurological impacts measured via the neuro-marketing techniques may be compared with the implicit attitudes and their resulting changes to assess whether there is any correlation between the two with respect to particular test subjects.

Example systems and methods to determine impact or effectiveness of test subject (e.g., media, a product, packaging, etc.) with these advancements and techniques are disclosed herein. An example method involves obtaining first implicit response data from a panelist at a first time period before an interaction during which the panelist is exposed to a test subject, obtaining second implicit response data from the panelist at a second time period after the interaction, and determining an impact of the test subject on the panelist based on the first and second implicit response data.

In some examples, the test subject comprises one or more of media, content, an advertisement, entertainment, a product, a product package, or a brand.

Some examples further involve obtaining third implicit response data from the panelist at a third time period after the interaction, the third time period being later than the second time period.

In some examples, the second time period ranges from substantially instantaneously after the interaction to one or more hours after the interaction, and the third time period ranges from more than an hour after the interaction to one or more months after the interaction.

Some examples further involve determining a first bias of the panelist before the interaction based on the first implicit response data, determining a second bias of the panelist based on the second implicit response data, and determining a direct impact of the test subject based on the first bias and the second bias.

Some examples further involve determining a third bias of the panelist based on the third implicit response data, and determining a residual impact of the test subject based on the first bias, the second bias, and the third bias.

In some examples, one or more of the first implicit response data or the second implicit response data is gathered while the panelist participates in implicit cognitive tasks.

In some examples, the implicit cognitive tasks include at least one of an implicit association task, a go-no-go task, a go-no-go association task, an affective priming task, a conditioning task, or an emotional picture viewing task.

In some examples, the implicit cognitive tasks are related to a concept associated with the test subject.

In some examples, one or more of the first implicit response data or the second implicit response data comprises at least one of a reaction time, a viewing time, a correct response, an incorrect response, a response direction, or a behavioral response associated with one of the implicit cognitive tasks.

Some examples further involve obtaining explicit response data from the panelist, the explicit response data comprising at least one of a survey metric or a diary entry.

Some examples further involve obtaining first neuro-response data from the panelist during the first time period before the interaction, obtaining second neuro-response data from the panelist during the interaction, and determining the impact of the test subject on the panelist based on the first neuro-response data and the second neuro-response data.

Some examples further involve determining an ongoing impact of the test subject on the panelist based on the second neuro-response data, wherein the second neuro-response data is to be obtained from the panelist throughout the first time period, the interaction, and the second time period.

In some examples, the interaction comprises multisensory stimuli involving more than one sensory modality.

In some examples, the interaction includes two, three, four, five, or all of a neutralization phase, an anticipation phase, a motor preparation phase, a sensation phase, an experience phase, or an evaluation phase. In some such examples, each phase is associated with one or more panelist actions having a fixed duration and a fixed sequence to enable aggregation of the second neuro-response data gathered during the phase with third neuro-response data gathered from a second panelist during a corresponding phase.

In some examples, the sensory modality comprises a somatosensory, a gustatory, or an olfactory sensory modality.

In some examples, the first neuro-response data is gathered while the panelist interacts with calibration stimuli to determine at least one of a baseline response tendency, a baseline response sensitivity, or a preference marker associated with the panelist.

In some examples, the calibration stimuli comprise at least one of a validated positive stimulus, validated negative stimulus, or a validated neutral stimulus corresponding to the more than one sensory modality.

In some examples, determining the impact of the test subject on the panelist comprises determining at least one of a preference of the panelist for a product associated with the test subject, a change in the preference for a product associated with the test subject, the preference for the product relative to another product, or an effect of a context on the change in the preference, the context comprising at least one of an advertisement, a packaging, or brand affiliation of the panelist associated with the product.

Some examples further involve obtaining video data of the physical activity of the panelist during the interaction, tagging the video data, tagging the second neuro-response data, and associating the tagged second neuro-response data with the tagged video data.

In some examples, one or more of the first neuro-response data or the second neuro-response data comprises one or more of a biometric response, electroencephalography data, electromyography data, functional magnetic resonance imaging data, electrooculography data, magnetoencephalography data, optical imaging data, a heart rate, an eye gaze, a facial expression, a skin conductance, or a behavioral response.

Furthermore, an example system disclosed herein includes an input interface to receive first implicit response data from a panelist at a first time period before an interaction during which the panelist is exposed to a test subject (e.g., media) and to receive second implicit response data from the panelist at a second time period after the interaction, and a data analyzer to analyze the first and second implicit response data to determine an impact of the test subject on the panelist.

In some examples, the input interface is to receive third implicit response data from the panelist at a third time period after the interaction, the third time period being later than the second time period.

In some examples, the data analyzer is to determine a first bias of the panelist before the interaction based on the first implicit response data determine a second bias of the panelist based on the second implicit response data, and determine a direct impact of the test subject based on the first bias and the second bias.

In some examples, the data analyzer is to determine a third bias of the panelist based on the third implicit response data, and determine a residual impact of the test subject based on the first bias, the second bias, and the third bias.

In some examples, one or more of the first implicit response data or the second implicit response data is gathered while the panelist participates in implicit cognitive tasks.

In some examples, the input interface is to receive explicit response data from the panelist via one or more explicit response data collectors, the explicit response data comprising at least one of survey metrics or diary entries.

In some examples, the input interface is to receive first neuro-response data from a panelist during the first time period before the interaction and second neuro-response data from a panelist during the interaction. In some such examples, the data analyzer is to determine the impact of the test subject on the panelist based on the first neuro-response data and the second neuro-response data

In some examples, the data analyzer is to determine an ongoing impact of the test subject on the panelist based on the second neuro-response data. The second neuro-response data is to be obtained from the panelist throughout the first time period, the interaction, and the second time period.

In some examples, the data analyzer is to determine at least one of a preference of the panelist for a product associated with the test subject, a change in the preference for the product associated with the test subject, the preference for the product relative to another product, or an effect of a context on the change in the preference. The context may be at least one of an advertisement, a packaging, or brand affiliation of the panelist associated with the product.

In some examples, the system further includes a data integrator to integrate the second neuro-response data with tagged video data of a physical activity of the panelist during the interaction to correlate a timing of the second neuro-response data to the physical activity of the panelist.

Additionally, an example tangible machine readable storage medium comprising instructions is disclosed herein which, when executed, cause a machine to at least obtain first implicit response data from a panelist at a first time period before an interaction during which the panelist is exposed to a test subject, obtain second implicit response data from the panelist at a second time period after the interaction, and determine an impact of the test subject on the panelist based on the first and second implicit response data.

In some examples, the machine readable instructions, when executed, further cause the machine to obtain third implicit response data from the panelist at a third time period after the interaction, the third time period being later than the second time period.

In some examples, the machine readable instructions, when executed, further cause the machine to determine a first bias of the panelist before the interaction based on the first implicit response data determine a second bias of the panelist based on the second implicit response data, and determine a direct impact of the test subject based on the first bias and the second bias.

In some examples, the machine readable instructions, when executed, further cause the machine to determine a third bias of the panelist based on the third implicit response data, and determine a residual impact of the test subject based on the first bias, the second bias, and the third bias.

In some examples, the machine readable instructions, when executed, further cause the machine to obtain first neuro-response data from the panelist during the first time period before the interaction, obtain second neuro-response data from the panelist during the interaction, and determine the impact of the test subject on the panelist based on the first neuro-response data and the second neuro-response data.

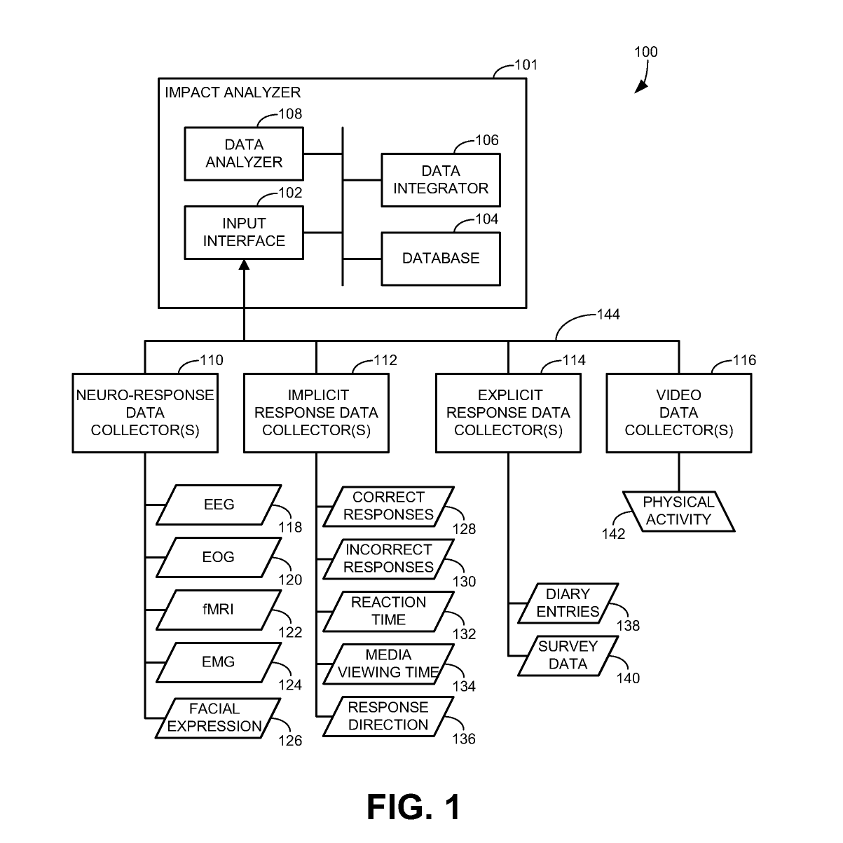

FIG. 1 is a schematic illustration of an example system 100 constructed in accordance with the teachings of this disclosure to determine an impact of a test subject on panelist(s) based on neuro-response data and implicit response data. The example system 100 of FIG. 1 includes an impact analyzer 101. In the illustrated example, the impact analyzer 101 includes an example input interface 102, an example database 104, an example data integrator 106, and an example data analyzer 108. The example input interface 102 receives input data via one or more data collectors. In the illustrated example, the data collectors include one or more neuro-response data collector(s) 110, one or more implicit response data collector(s) 112, one or more explicit response data collector(s) 114, and/or one or more video data collector(s) 116. The example database 104 of FIG. 1 stores the received input data. The data integrator 106 correlates and/or integrates the input data. Finally, the example data analyzer 108 of the example system 100 of FIG. 1 analyzes the input data. Each of these components will be discussed in greater detail below.

The example neuro-response data collector(s) 110 of FIG. 1 obtain neuro-response data from panelist(s) before, during, and/or after the panelist(s) are exposed to the test subject of interest (e.g., media, a product, etc.). The example neuro-response data collector(s) 110 of FIG. 1 may include, for example, one or more electrode(s), camera(s) and/or other sensor(s) to gather any type(s) of neurological, physiological, and/or biological data, including, for example, brain activity based on functional magnetic resonance imaging (fMRI) data and/or electroencephalography (EEG) data, magnetoencephalography (MEG) data and/or optical imaging data. The neuro-response data collector(s) 110 of the illustrated example may gather data continuously, periodically and/or aperiodically.

The neuro-response data collector(s) 110 of the illustrated example gather neurological, biological and/or physiological measurements such as, for example, central nervous system measurements, autonomic nervous system measurement(s) and/or effector measurement(s), which may be used to evaluate the panelist(s) for individual biosensitivities to certain stimuli, baseline response patterns, and/or reaction(s) and/or impression(s) of one or more test subject(s). Some examples of central nervous system measurement mechanisms that are employed in some examples detailed herein include fMRI, EEG, MEG and optical imaging. Optical imaging may be used to measure the absorption or scattering of light related to concentration of chemicals in the brain or neurons associated with neuronal firing. MEG measures magnetic fields produced by electrical activity in the brain. fMRI measures blood oxygenation in the brain that correlates with increased neural activity.

EEG measures electrical activity resulting from a large number of simultaneous neural processes associated with different portions of the brain. EEG also measures electrical activity associated with post synaptic currents occurring in the milliseconds range. Subcranial EEG can measure electrical activity with high accuracy. Although bone and dermal layers of a human head tend to weaken transmission of a wide range of frequencies, surface EEG provides useful electrophysiological information. In addition, portable EEG with dry electrodes also provides useful neuro-response information.

Autonomic nervous system measurement mechanisms that are employed in some examples disclosed herein include electrocardiograms (EKG), pupillary dilation, galvanic skin responses (GSR), etc. Effector measurement mechanisms that are employed in some examples disclosed herein include electrooculography (EOG), eye tracking, facial emotion encoding, reaction time, etc. Also, in some examples, the neuro-response data collector(s) 110 collect other type(s) of central nervous system data, autonomic nervous system data, effector data and/or other neurological and/or biological data. Central nervous system data, autonomic nervous system data, effector data, neurological data, physiological data and/or biological data are collectively and/or individually referred to herein as neuro-response data. The example collected neuro-response data may be indicative of one or more of alertness, engagement, attention, memory, and/or resonance (e.g., the amount a test subject or instance of the test subject affects or resonates with a subject).

In the illustrated example, the neuro-response data collector(s) 110 collect neurological and/or physiological data from multiple sources and/or modalities. In the illustrated example, the neuro-response data collector(s) 110 include components to gather EEG data 118 (e.g., scalp level electrodes), components to gather EOG data 120 (e.g., shielded electrodes), components to gather fMRI data 122 (e.g., a differential measurement system), components to gather EMG data 124 to measure facial muscular movement (e.g., shielded electrodes placed at specific locations on the face) and/or other muscular activity of the panelist(s), and/or components to gather facial expression data 126 (e.g., a video analyzer). The neuro-response data collector(s) 110 may also include one or more additional sensor(s) to gather data related to any other biosensory metric including, for example, GSR data to determine skin conductance, MEG data, EKG data, optical imaging data, pupillary dilation data, eye tracking data, facial emotion encoding data and/or reaction time data. Other example sensors include cameras, microphones, motion detectors, gyroscopes, temperature sensors, etc., which may be integrated with or coupled to the neuro-response data collector(s) 110. In some examples, only a single neuro-response data collector 110 is used. In other examples a plurality of neuro-response data collectors 110 of one or more type(s) are used.

The implicit response data collector(s) 112 of the illustrated example gather measurements of implicit responses from panelist(s) while participating in one or more implicit cognitive tests (ICTs), sometimes referred to herein as implicit cognitive tasks. Such implicit measures may be used to evaluate the implicit or automatic attitudes or biases of panelist(s) regarding any desired subject matter and/or the impact of one or more test subject(s) on such implicit biases directly after interacting with the test subject(s) (e.g., a direct or short-term impact) and/or over a span of time (e.g., a long-term or residual impact). Some example ICTs include an implicit association task (IAT), a go-no-go task, a go-no-go association task, an affective priming task, a conditioning task, or an emotional picture viewing task.

The IAT is an implicit measure used to detect a panelist's automatic association (i.e., based on implicit cognition) of concepts (e.g., competing products, product types, or brands, etc.) and/or attributes. An IAT involves panelist(s) pairing a target concept (e.g., a brand or product, such as, for example, a minivan) and a distractor concept (e.g., a truck) with two poles of an attribute (e.g., good/bad). The speed at which panelist(s) associate the concepts and attributes is an indication of their automatic attitudes. An example IAT involves four different tasks that may be repeated one or more times during a complete test procedure. A first task involves providing a successive set of stimuli (e.g., words and/or images) some of which are associated with the target concept while others are associated with the distracter concept. As each stimulus is presented to panelist(s), the panelist(s) are to identify whether the stimulus is associated with the target concept or the distracter concept. In some examples, panelist(s) participate in the IAT via a computer and indicate the category (e.g., target or distracter concept) by pressing a key on a computer corresponding to each of the categories. A second task involves a similar process of providing successive stimuli associated either with the attribute (e.g., good) or the attribute's opposite (e.g., bad) and the panelist(s) are to classify each stimulus as it appears into either the attribute or the attribute's opposite. A third task involves combining one concept with the attribute (e g , minivan+good) and the other concept with the attribute's opposite (e.g., truck+bad) and panelist(s) are provided stimuli associated with any of the target concept, the distracter concept, the attribute, and/or the attribute's opposite. The panelist(s) are to classify each stimulus into either of the concept-attribute combinations. A fourth task involves cross-combining the concepts and attributes such that the first concept is combined with the attribute's opposite (e.g., minivan+bad) and the second concept is combined with the attribute (e.g., truck+good). The panelist(s) again classify successive stimuli into the appropriate combined category.

Throughout the IAT procedure the panelist(s) attempt to identify the proper category corresponding to each stimulus as fast as possible and the response time or reaction time for each stimulus is recorded. The reaction times during the initial tasks of the IAT provide a baseline for the response sensitivity of the panelist(s) with respect to the different stimuli and the reaction times during the combined stages enable researchers to determine the implicit attitude or bias of the panelist(s) with respect to the tested attribute as it relates to the tested concepts. Faster responses are interpreted as easier associations between the concept and the attribute for the panelist(s) and, therefore, suggest a stronger association in implicit cognition of the panelist(s). For example, panelist(s) who are faster for a concept related stimuli (e.g., an image of a minivan) when the concept is grouped into a combined category with a positive (e g , minivan+good), indicates that the panelist(s) have an automatic bias in favor of the concept (e.g., minivans). In contrast, slower response times indicate a more difficult pairing that is interpreted as an implicit bias against the association of the concept and attribute. In addition to reaction times, panelist(s) may incorrectly identify the corresponding category for one or more stimuli in any of the tasks of the IAT. Accordingly, the number of correct and incorrect responses, in conjunction with the response time for each, may be evaluated to further assess the implicit attitudes of the panelist(s).

This process has concrete applications in market research. For example, the IAT may be used to identify the automatic preference of panelist(s) for a first product (e.g., the first concept) over a competing product (e.g., the second concept) and/or any implicit bias of the panelist(s) towards or against a particular brand or product.

A Go/No-go test is another ICT that involves a series of pass/fail trials that present the panelist(s) with a stimulus (e.g., a word or an image) that may (“Go”) or may not (“No-go”) correspond to a particular attribute or condition and its opposite (e.g., good/bad). In some examples, rather than an attribute and its opposite, the Go/No-go test studies the presence of the attribute against its absence (e.g., Red versus not Red). When a particular stimulus corresponds to the attribute the panelist(s) are to perform an action (e.g., a “Go” trial), such as pressing a button. In contrast, when the stimulus of a particular trial does not correspond to the attribute, the panelist(s) are to refrain from performing an action (e.g., a “No-go” trial). In some examples, the action is the panelist(s) pressing a button, such as the space bar on a computer implementing the test. The stimulus corresponding to each successive trial is presented for a fixed amount of time (e.g., one second) at variable interstimulus intervals (ISIs). During the series of trials, implicit response data is collected that includes the number of correct responses (action for “Go” trials and non-action for “No-go” trials), the number of incorrect responses (non-action for “Go” trials and action for “No-go” trials), and the response or reaction time in performing the “Go” action (either during a correct “Go” trial and/or during an incorrect (false-positive) “No-go” trial).

In some example, the Go/No-go tests involve generic stimuli that do not incite any particular emotions. For example, panelist(s) may be required to perform an action (“Go”) every time a “W” appears but do nothing (“No-go”) when an “M” appears. Based on the collected implicit response data, a baseline attention and response sensitivity (e.g., accuracy) of the panelist(s) may be determined Other Go/No-go tests build upon this generic test to assess the emotional state of panelist(s) by incorporating known or validated positive, negative, and/or neutral stimuli. Validated stimuli are stimuli which have normative ratings of emotional incitement or valence (e.g., affective norms) such as, for example, images in the International Affective Picture System (IAPS) developed by the Center for Emotion and Attention at the University of Florida. For example, panelist(s) are to perform an action (“Go”) when a “W” appears and do nothing (“No-go”) when an “M” appears, as in the prior test. However, along with the letters, there is a validated (e.g., emotionally rated) positive, negative, or neutral stimulus (e.g., an IAPS-like image). When a positively rated stimulus appears with a “W” (a “Go” trial) panelist(s) will typically perform the action faster than when a negatively rated stimulus appears with the “W.” Similarly, panelist(s) are more likely to incorrectly perform the action when a positively rated stimulus appears with an “M” (a “No-go” trial) and less likely for a negatively rated stimulus. Comparing the response times and number of correct and incorrect responses with the implicit response data of the generic Go/No-go test described above, the example system 100 may determine the baseline mood of the panelist(s) and/or the emotional response sensitivity of the panelist(s) to different types of stimuli. For example, a positive emotional state of the panelist(s) may be demonstrated by faster response times during “Go” trials and more false positives during “No-go” trials in the presence of positive stimuli as compared with negative stimuli. In contrast, where the panelist(s) have a negative emotional state, responses during “Go” trials will be slower or missed altogether more often when presented in conjunction with a positive stimulus.

Another example of the Go/No-go test is similar to the emotionally based test described above except that rather than being presented with emotionally validated stimuli, the panelist(s) are presented with stimuli that relate to a concept of interest to researchers, such as a target product. The stimuli may relate to the product including, for example, images of the product. This example may be used to assess the response sensitivities of the panelist(s) with respect to the concept (or product) and/or the impact of the concept (or product) on the panelist(s) (e.g., a change in their implicit attitudes). For example, a positive bias towards a target product is demonstrated by faster response times for “Go” trials and increased accuracy when compared with stimuli of other products or stimuli unrelated to the target product. Similarly, slower response times and more incorrect responses demonstrate a negative bias against the target product. As each panelist may have different response tendencies and/or different emotional response sensitivities than other panelists, in some examples disclosed herein, all three of the above mentioned implementations of the Go/No-go test may be employed. The generic and emotional based stimuli tests may be used as calibration mechanisms to establish baseline response tendencies and sensitivities of the panelist(s) so that the implicit response data collected during the test of the test subject can be appropriately analyzed.

The Go/No-go Association test (GNAT) is another implicit cognitive test that combines aspects of the IAT and a Go/No-go test to determine the implicit attitude of panelist(s) with respect to a concept and an attribute. Rather than classifying stimuli into one of two combined categories as in the IAT (e g , minivan+good and truck+bad), the GNAT defines one combined category and then provides stimuli associated with any of the concept, attribute, and/or the attribute's opposite in successive timed trials. If a particular stimulus corresponds to the combined category, the panelist(s) are to perform some act (“Go”), and if the stimulus does not correspond to the combined category, the panelist(s) are to do nothing (“No-go”) as in the Go/No-go test. Other examples apply the “Go” tasks to stimuli unrelated to the combined category defined by the test and the “No-go” tasks to the related stimuli. Thus, while the IAT compares one concept to another (e.g., minivans versus trucks), the GNAT may focus on a single concept. Furthermore, while the IAT compares one concept or category with another concept, the GNAT can also compare the target concept with a more generic concept or context that may provide a more useful control for comparison (e.g., minivans versus vehicles).

As disclosed above, the GNAT, as well as other implicit measures, focuses on testing implicit attitudes towards products and/or corresponding brands. In other examples, the GNAT may be used to assess implicit attitudes of panelist(s) towards general concepts relating to test subjects (e.g., target products and/or brands). For example, these disclosed methods may include assessing the implicit biases of panelist(s) towards ‘healthy’ foods, which may be relevant to, for example, producers marketing low sodium soup. A GNAT to measure such biases may involve asking panelist(s) to review each of a number of categories and stimuli (e.g. words) associated with each category. The categories may include “good,” “bad,” “healthy,” and “unhealthy.” The words associated with the “good” category may include, for example, happy, peace, unity, beauty, joy, socially-conscious, love, youthful, exciting, and/or harmony. The words associated with the “bad” category may include, for example, sad, war, conflict, ugly, despair, greedy, hate, old, boring, and/or tension. The words associated with the “healthy” category may include, for example, organic, natural, free, low, slim, vegetable, wholesome, beneficial, nourishing, and/or fit. The words associated with the “unhealthy” category may include, for example, processed, detrimental, artificial, sugar, fat, damaging, synthetic, salt, heavy, and/or high.

In this example GNAT, one of the “healthy” or “unhealthy” categories is grouped with one of the “good” or “bad” categories to be displayed in conjunction with the stimuli for panelist(s) to respond to during each trial. For example, a first trial may display “good” and “healthy” and then any one of the words from any of the four categories listed above. A subsequent trial may display “good” and “unhealthy” along with another term from any of the four category lists. When the displayed term corresponds to either of the displayed categories, the panelist(s) are to perform an action (“Go”), whereas when the displayed term does not correspond to either category displayed, the panelist(s) are to do nothing (“No-go”). Depending upon the response time and/or the number of correct or incorrect trials, the implicit attitude of the panelist(s) may be determined.

Yet another example ICT that may be implemented in certain examples disclosed herein is passive emotional picture viewing tasks. Such tasks involve panelist(s) viewing emotionally validated images (e.g., IAPS images) and indicating whether they like the image or dislike it. Thus, unlike the previous ICTs, there is no correct or incorrect response, and responses need not be given as fast as possible. In such tests, the implicit response data collected includes the response direction (e.g., like or dislike), and the time spent viewing each image or other stimulus.

In addition to the above disclosed implicit cognitive tasks, other suitable ICTs may be used in conjunction with the examples disclosed herein. In the illustrated example system 100, the implicit response data collector(s) 112 include components to present the ICTs (e.g., a computer screen) and receive panelist responses (e.g., a computer keyboard) to collect any desired implicit response data including correct responses 128, incorrect responses 130, response or reaction time 132, viewing time 134, response direction 136 (e.g., like or dislike) and/or any other desired implicit response data. In some examples, the implicit response data collector(s) 112 may be paper or booklets with questionnaires and/or space for panelist(s) to write in responses to be subsequently submitted to the example system 100 via the input interface 102. In other examples, the implicit response data collector(s) 112 include any sort of output display device to present stimuli, any sort of input device to receive responses, and/or components to time the responses and/or the duration the stimuli are presented. In some examples, only a single implicit response data collector 112 is used to perform any number or type(s) of ICTs. In other examples a plurality of implicit response data collectors 112 may be used.

The example system 100 of FIG. 1, may also receive explicit response data via one or more explicit response data collector(s) 114. Such explicit response data includes one or more diary entries 138, survey data 140, and/or any other self-reported data from the panelist(s). Accordingly, in the illustrated example, the explicit response data collector(s) 114 include one or more of a diary, a paper survey, a questionnaire, and/or a device (e.g., a computer) to provide survey question(s) and/or receive/store response(s). In some examples, the implicit response data collector(s) 112 may be integrated with the explicit response data collector(s) 114.

The illustrated example system 100 also includes video data collector(s) 116 to be used in some examples disclosed herein to capture physical activity data 142 of the panelist(s) that is timestamped to tag specific events of interest (e.g., physical movement of the panelist(s) during the interaction). In some such examples, the tagged video data is used to tag the neuro-response data and/or other collected data at the precise times of the specific events of interest to correlate and/or integrated all the collected data via the data integrator 106. In this manner, the system 100 of the illustrated example is able to identify the collected data corresponding to the physical activity of the panelist(s) that is of interest, and the physical activity that is mere extra movement artifacts that add to the noise in the brain signals collected as part of the neuro-response data. By identifying extra movement artifacts from movements of interest, the data may be analyzed more reliably as will be described more fully below. As such, the video data collector(s) 116 include any sort of video camera to record the behavior and/or physical activity of the panelist(s), a timestamper to timestamp the video to be integrated with date, time, and/or other identification components to tag the video with other collected data. In some examples, only a single video data collector 116 is used. In other examples, multiple numbers and/or type(s) of video data collector(s) 114 are employed.

Data collection is performed automatically in the example of FIG. 1 and sent to the impact analyzer 101 via the input interface 102. In the example system 100 of FIG. 1, the data collector(s) 110, 112, 114, 116 are communicatively coupled to other components of the impact analyzer 101 via a bus and/or communication links 144. The communication links 144 may be any type of wired (e.g., a databus, a USB connection, etc.) or wireless communication mechanism (e.g., radio frequency, infrared, etc.) using any past, present or future communication protocol (e.g., Bluetooth, USB 2.0, etc.). Also, the components of the example system 100 may be integrated in one device or distributed over two or more devices.

The database 104 of the example system 100 stores any of the neuro-response data, implicit response data, explicit response data, and/or video data received from any of the data collector(s) 110, 112, 114, 116 for later integration and/or analysis by the example data integrator 106 and the data analyzer 108. In some examples, the collected data is analyzed in real-time or substantially real-time. In some examples, the neuro-response data collected is digitally sampled before storage. In some examples, the digital sampling rates to collect the neuro-response data are adaptively chosen based on the type(s) of physiological, neurophysiological and/or neurological data being measured.

The data integrator 106 of the illustrated example correlates the various types of data for analysis, both with the other types of data and with data corresponding to different panelists. For example, the data integrator 106 processes the tagged video data and associates key points in time (e.g., times of specific movement of the panelist(s)) with the implicit response data and/or the neuro-response data.

The example data analyzer 108 of FIG. 1 receives the data gathered from the data collector(s) 110, 112, 114, 116 and analyzes the different types of data separately and/or in combination for trends, patterns and/or relationships. For example, in some disclosed examples described herein, panelist(s) participate in a first set of ICTs that include tasks to collect implicit response data (e.g., 128, 130, 132, 134, 136) that the data analyzer 108 uses to determine each panelist's baseline response tendencies and emotional state as well as any implicit bias with respect to a product of interest and/or a corresponding brand. Following the first set of ICTS, the panelist(s) interact with a test subject associated with the product and/or brand of interest such as related media (e.g., an advertisement for the product and/or brand). In some examples, the test subject the panelist(s) interact with may be the product that is of interest. Also, a second set of ICTs is performed after the test subject interaction to collect data that the data analyzer 108 analyzes to determine each panelist's bias towards or against the test subject (e.g., the product and/or brand of interest). With the analysis of the first and second sets of ICTs, the example data analyzer 108 compares the determined biases from each set of ICTs. Any change in implicit bias would be indicative of the interaction having an impact on the corresponding panelist's attitude toward the test subject.

In addition, in some examples, neuro-response data (e.g., 118, 10, 122, 124, 126) may be collected throughout the entire testing procedure (i.e., during the first set of ICTs, the interaction, and the second ICT). Such data is analyzed by the data analyzer 108 to identify one or more of alertness, engagement, attention, memory, and/or resonance of the panelist(s) and any changes in such data over time. Thus, in addition to assessing implicit bias before and after an interaction (with, for example, media and/or a product), the examples disclosed herein assess the ongoing or continuous impact of the interaction of the panelist(s) with the test subject, and/or the exposure of the panelist(s) to the related stimuli during the ICTs undertaken before and after the test subject interaction. Combining both the implicit measures of the impact with the neurological measures of the impact provide a more complete picture of the effects of the test subject (e.g., an advertisement).

In some examples, the collected data is tagged and correlated with tagged video data at key points in time. For example, an interaction may involve multisensory stimuli, which includes, for example, the sense of taste. For panelist(s) to interact with such test subjects through multiple sensory modalities, the panelist(s) typically move by, for example, opening their mouths, inserting the test subject into their mouths (e.g., a food product), and swallowing. In the illustrated examples, the motion of the panelist(s) is captured with the video data collector(s) 116 so that the particular actions (e.g., lifting the test subject to their mouths, opening their mouths, inserting the test subject, closing their mouths, retuning their arm to the table, swallowing, etc.) can be precisely identified and synced with the neuro-response data and/or other collected data via the data integrator 106 to assist the data analyzer 108 in identifying relevant neuro-response data signals (e.g., taste response when the test subject is in the panelist(s) mouths) from extra movement artifacts (e.g., returning their arm to the table) to reduce the amount of noise and isolate relevant neuro-response data for further analysis.

Additionally, the example data analyzer 108 of FIG. 1 analyzes data collected from multiple panelists to determine trends and/or extrapolate the impact of the test subject (e.g., media) to larger populations. To enable the integration of data for such analysis, the ICTs and interactions in some examples are controlled based on the actions required of the panelist(s) and the sequence and duration of those actions as described below.

One or more of the elements, processes and/or devices illustrated in FIG. 1 may be combined, divided, re-arranged, omitted, eliminated and/or implemented in any other way. Further, the example impact analyzer 101, the example input interface 102, the example database 104, the example data integrator 106, the example data analyzer 108, the example data collectors 110, 112, 114 and 116 and/or, more generally, the example system 100 of FIG. 1 may be implemented by hardware, software, firmware and/or any combination of hardware, software and/or firmware. Thus, for example, any of the example impact analyzer 101, the example input interface 102, the example database 104, the example data integrator 106, the example data analyzer 108, the example data collectors 110, 112, 114 and 116 and/or, more generally, the example system 100 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example the example impact analyzer 101, the example input interface 102, the example database 104, the example data integrator 106, the example data analyzer 108, the example data collectors 110, 112, 114 and 116 and/or, more generally, the example system 100 are hereby expressly defined to include a tangible computer readable medium such as a memory, DVD, CD, Blu-ray, etc. storing the software and/or firmware. Further still, the example system 100 of FIG. 1 may include one or more elements, processes and/or devices in addition to, or instead of, those illustrated in FIG. 1, and/or may include more than one of any or all of the illustrated elements, processes and devices.

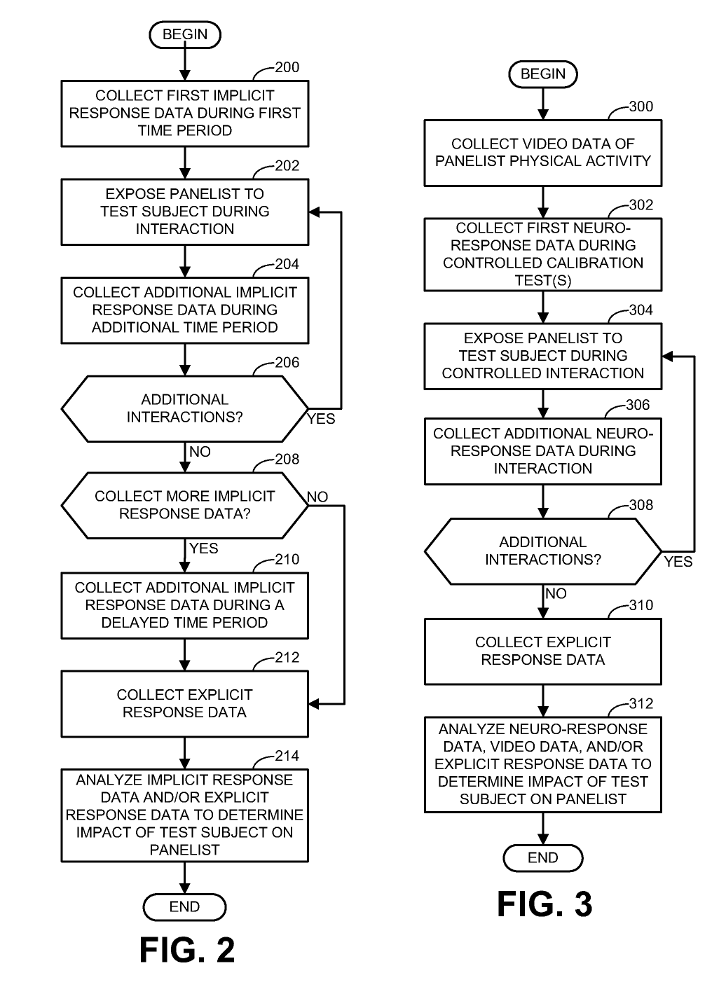

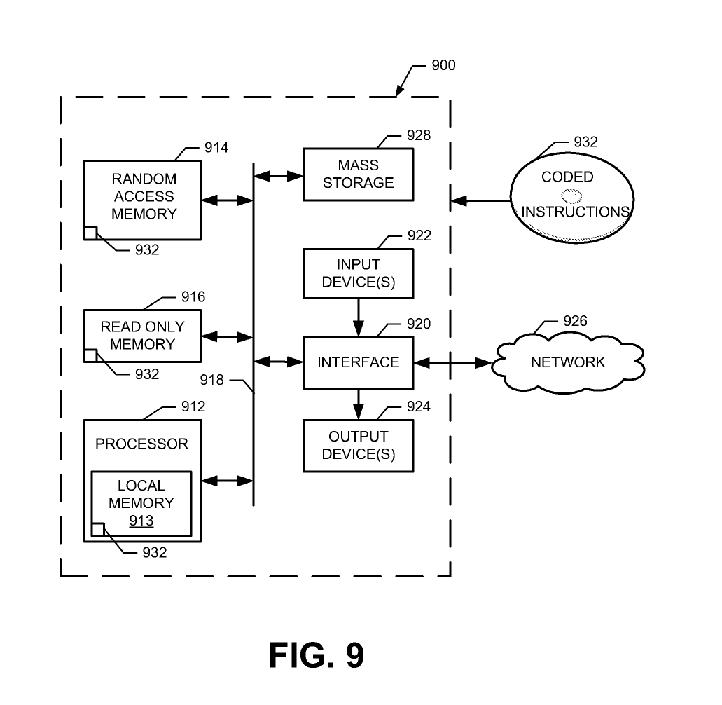

Flowcharts representative of example processes and/or machine readable instructions that may be carried out to implement the example system 100 of FIG. 1 are shown in FIGS. 2-7. More particularly, FIGS. 2-7 may be representative of machine readable instructions for implementing the system 100 of FIG. 1. In these examples, the machine readable instructions comprise a program for execution by a processor such as the processor 912 shown in the example processor platform 900 discussed below in connection with FIG. 9. The program may be embodied in software stored on a tangible computer readable medium such as a CD-ROM, a floppy disk, a hard drive, a digital versatile disk (DVD), a BluRay disk, or a memory associated with the processor 912, but the entire program and/or parts thereof could alternatively be executed by a device other than the processor 912 and/or embodied in firmware or dedicated hardware. Further, although the example processes are described with reference to the flowcharts illustrated in FIGS. 2-7, many other methods of implementing the example system 100 may alternatively be used. For example, the order of execution of the blocks may be changed, and/or some of the blocks described may be changed, eliminated, or combined.

As mentioned above, the example processes of FIGS. 2-7 may be implemented using coded instructions (e.g., computer readable instructions) stored on a tangible computer readable medium such as a computer readable storage medium (e.g., a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information)). As used herein, the term tangible computer readable medium is expressly defined to include any type of computer readable storage and to exclude propagating signals. Additionally or alternatively, the example processes of FIGS. 2-7 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

The example flowchart of FIG. 2 begins at block 200 where first implicit response data is collected during a first time period. During the first time period, one or more suitable ICTs may be implemented and the corresponding implicit response data collected (e.g., via the implicit response data collector(s) 112 and/or any other suitable data collection device). In some examples, the ICTs include generic and/or emotional based Go/No-go tasks, picture viewing tasks, and/or any other suitable implicit task to determine initial or pre-exposure implicit attitudes, emotional states, and/or response sensitivities of panelist(s) to calibrate the implicit response data collected throughout the example process.

Additionally, in the illustrated example, the ICTs include implicit tasks that involve stimuli associated with test subject(s) (e.g., media of interest (e.g., an ad) and/or product(s) and/or brand(s) corresponding to the media of interest). Such test subject focused ICTs may also be implemented during the first time period before the panelist(s) interact with the test subject. For example, if the test subject is a television commercial for a BMW automobile, the implicit response data collector(s) (e.g., 112) may implement a GNAT that incorporates images of the BMW automobile tested against one or more attributes (e.g., good/bad). Additionally or alternatively, the implicit response data collector(s) (e.g., 112) may implement a passive viewing task that presents a series of brand images interspersed with IAPS-like emotionally rated images. In other examples, the implicit response data collector(s) (e.g., 112) may present stimuli related to the test subject (e.g., images of the BMW automobile) along with stimuli relating to competing products and/or brands (e.g., images of a Volkswagen automobile and/or images of a Mercedes Benz automobile, etc.). In this manner, the initial or pre-exposure implicit bias of the panelist(s) towards the product and/or brand corresponding to the test subject can be assessed, and/or the initial implicit bias of the panelist(s) towards the test subject relative to other test subjects (e.g., other products) can be assessed.

Once the implicit response data is collected, the panelist(s) are exposed to the test subject (e.g., target media) during a controlled interaction (block 202). In some examples, the interaction is provided via the implicit response data collector(s) (e.g., 112). In other examples, the interaction may be provided via any other suitable device. In some examples, the test subject is a physical object (e.g., a product) in which case the panelist(s) are presented with the object itself. However, when the test subject is a physical object, the object may be covered or otherwise concealed prior to the interaction so as not to affect the pre-exposure ICTs. In some such examples, instructions of when and/or how to uncover, access, and/or interact with the object may be presented via the implicit response data collector(s) (e.g., 112) or other device.

In the example process of FIG. 2, second implicit response data is collected (e.g., via the implicit response data collector(s) 112) during a second time period after the interaction (block 204). In some examples, the implicit response data collector(s) (e.g., 112) and/or any other device implements additional ICTs as the basis for the implicit response data collected via the implicit response data collector(s) (e.g., 112) . In some examples, the same or similar ICTs used during the first time period may be used in the second time period. In other examples, different ICTs are implemented during the second time period. Furthermore, in the illustrated example, the ICTs during the second time period may present the same and/or similar stimuli used in the ICTs during the first time period. In this manner, implicit response data related to the test subject is collected both before and after the interaction to determine an initial implicit attitude before the interaction (e.g., a pre-exposure bias) and a subsequent implicit attitude after the interaction (e.g., a post-exposure bias). The pre-exposure bias may be compared with the post-exposure bias to determine an impact of the test subject by identifying any change or shift in the bias of the panelist(s). Additionally, while the ICTs during the first time period of the example process include tasks to determine the generic and emotional based response tendencies of the panelist(s), the ICTs implemented during the second period may focus on tasks associated with the test subject (e.g., media, product(s), and/or brand(s)) because data to determine the baseline response tendencies of the panelist(s) has already been gathered. However, in other examples, additional generic and/or emotional based ICTs may be implemented during the second time period to measure any change in the generic baseline automatic attitudes of the panelist(s).

The example process determines whether the panelist(s) are to be exposed to additional test subject(s) during additional interactions (block 206). If the panelist(s) are to be exposed to additional test subject(s), the example process returns to block 202 to expose the panelist(s) to the additional test subject(s) and to block 204 where additional (e.g. third) implicit response data is collected. This process may be repeated any desired number of times. When the panelist(s) are exposed to different test subject(s) during multiple interactions, each interaction may be separated by an additional time period implementing additional ICTs represented at block 204. In such examples, each additional time period not only provides additional data to determine the post-exposure bias resulting from the preceding test subject exposure, the additional data of the additional time period also serves to determine a pre-exposure bias used in assessing the impact of a subsequent interaction. Thus, the example process of FIG. 2 enables a determination of the impact of each test subject exposed to the panelist(s) by comparing the implicit response data collected directly before the corresponding interaction (which may correspond to data collected directly after a preceding interaction) and the implicit response data collected directly after the interaction (which may correspond to data collected directly before a subsequent interaction).

In some examples, each additional interaction involves a test subject corresponding to the prior test subject (e.g., the same product and/or brand). In some such examples, a general preference of favorability of the panelist(s) for the product and/or brand may be assessed. In other examples, the multiple interactions may involve test subject(s) associated with different variations of a same product (e.g., regular and low sodium soup under the same brand) and/or different but related products and/or brands (e.g., competing products and/or brands). In such examples, the preference of panelist(s) for one product and/or brand over another product and/or brand may be assessed. Further, in some examples, the interactions may involve different types of test subjects (e.g. the test subject of the first interaction may be a television commercial for a product while the test subject of a later interaction is the product itself). In some examples, the order of each interaction may vary between different panelists to assess any priming effects of each interaction on subsequent interactions.

In the illustrated example, the first time period before a first of the one or more interactions ranges, for example, from one or more hours before the interaction to substantially instantaneously before the interaction. Comparably, the time period when the additional implicit response data is collected after each of the one or more interaction(s) ranges, for example, from substantially instantaneously after the interaction to one or more hours after the interaction. The relatively immediate succession of collecting the first implicit response data, providing the interaction, and collecting the additional implicit response data enables the example systems and methods disclosed herein to assess a direct impact (i.e., a short-term) impact of the test subject on the automatic attitudes of panelist(s). If no additional interactions are to be provided (block 206), the example method determines whether additional implicit response data is to be gathered during a delayed time period (block 208). If additional implicit response data is to be gathered, the additional implicit response data is collected during such a delayed time period (block 210) (e.g., via the example implicit response data collector(s) 112). In the illustrated example, the delayed time period ranges from, for example, more than an hour after the interaction to one or more months after the interaction. In some examples, such implicit response data is collected from panelist(s) participating in additional ICTs in the same manner as described above and may be used to assess any residual or long-term impact and/or behavioral outcomes resulting from the test subject by comparing the additional data to the data collected at blocks 200 and 204. In some examples, the additional implicit response data is collected from panelist(s) tested in group(s) or panel(s).

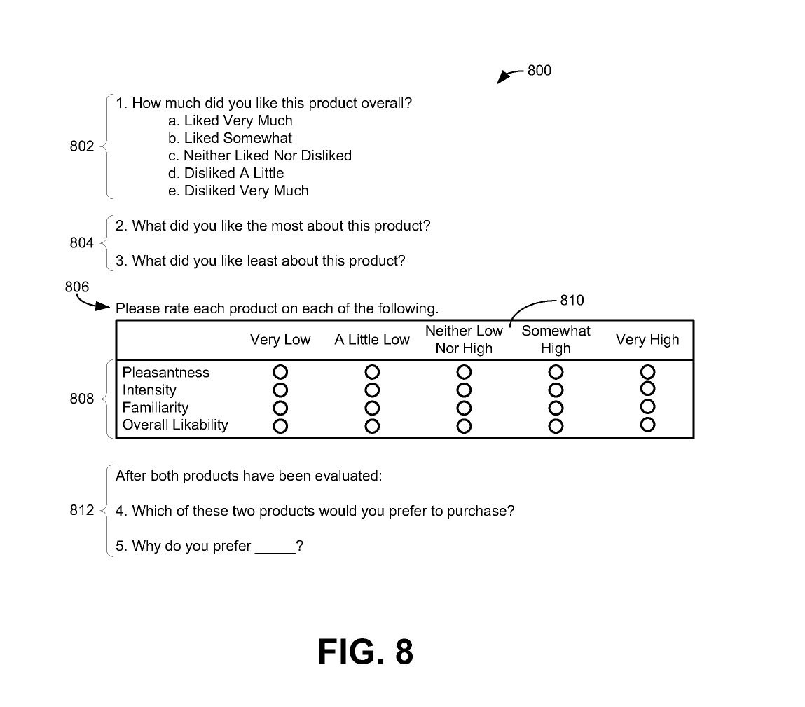

In the example process of FIG. 2, explicit response data is collected (block 212) (e.g., via the explicit response collector(s) 114). Similarly, if additional implicit response data is not be collected during a delayed time period (block 208) the example process advances to block 212 to collect the explicit response data. In some examples, the explicit response data includes one or more survey(s) to collect biographic and/or demographic information related to the panelist. Furthermore, in the disclosed examples, explicit response data is collected to measure individual factors that may influence the responses of the panelist(s), consumer habit(s), and/or motivation(s) of the panelist(s). Additionally, in some examples, the explicit response data includes information relating specifically to the test subject such as, for example, the subjective rating(s) of the panelist(s) regarding the test subject with which they interacted for comparison with the their implicit responses to the test subject. In some examples, the explicit response data is collected via survey questionnaire(s). Question(s) included within such survey(s) may vary depending on the type(s) and/or number of interactions. For example, where the panelist(s) were exposed to a first test subject associated with a product and/or brand and then a second test subject associated with a competing product and/or a brand, the survey may include question(s) asking the panelist(s) to select the product and/or brand the panelist(s) prefer and/or why it is preferred. In contrast, where all interactions are associated with a same target product and/or brand, the panelist(s) may be asked to identify which test subject had the greatest impact on the panelist(s) regarding the target product. Example, questionnaires are discussed below in connection with FIG. 8.

In addition, in the example process of FIG. 2, the collected implicit response data and/or explicit response data are analyzed (e.g., via the analyzer 108) to determine the impact of the test subject on the panelist(s) (block 214). The first implicit response data is analyzed to determine a baseline emotional state and/or response tendencies and/or sensitivities of the panelist(s) from which the additional implicit response data can be calibrated. Furthermore, the implicit response data collected during each time period that included stimuli relating to a target product and/or competing products and/or corresponding brand(s) is analyzed to determine the implicit bias or automatic attitude of the panelist(s) with respect to the tested product(s) and/or brand(s). The resulting bias determined for each time period is placed in sequence with the one or more interactions to identify a pre-exposure bias and post-exposure bias for each corresponding interaction. The pre-exposure bias and post-exposure bias surrounding each interaction are compared (e.g., by the analyzer 108) to determine the impact of the corresponding test subject on the panelist. For example, if the test subject is media (e.g., an ad) a greater post-exposure bias in favor of a product associated with the media than the pre-exposure bias towards the product indicates the media had a positive impact on the panelist(s). Additionally, in examples with multiple interactions, the degree of impact of one test subject against another may be compared. In such examples, the panelist(s) overall preferences for a test subject (e.g., a product and/or brand) can be assessed as well as the progression of the bias of the panelist(s) as they are exposed to each additional test subject. Furthermore, the preference of the panelist(s) for one product and/or brand over another product and/or brand may be assessed. Finally, the implicit attitudes and/or impacts of the test subject can be compared with the explicit responses and/or impacts of the test subject reported by the panelist(s) to assess how accurately the panelist(s) appreciate their internal biases. After the collected data has been analyzed, the example process of FIG. 2 ends.

FIG. 3 is a flow chart representative of another example process that may be performed to determine an impact of a test subject on panelist(s) and/or, more generally, to implement the example system 100 of FIG. 1. The example process of FIG. 3 includes collecting video data of the physical activity of the panelist(s) (block 300). The video data may be captured, for example, by one or more video data collector(s) (e.g., 116), which may tag the video data to be correlated and/or integrated with neuro-response data to identify extra movement artifacts as described above. The identified artifacts may be processed as detailed above to limit the effects of the artifacts on the neuro-response data. In some examples the video data is collected throughout the entire example process of FIG. 3. The example process of FIG. 3 further includes collecting first neuro-response data during controlled calibration test(s) (block 302). The data may be collected, for example, by the neuro-response data collector(s) 110. In some examples, the data may be collected during the presentation of validated and/or standardized stimuli similar to the stimuli of the ICTs described above in connection with the example process of FIG. 2. Additionally or alternatively, when the example test subject is a physical object (e.g., a target product), the interaction may involve multisensory stimuli. In such examples, the calibration test in the illustrated examples also includes validated positive, negative, and neutral stimuli in the same modality as the target product to enable mapping the responses of the panelist(s) to the target product. As discussed above, validated stimuli are stimuli that have been normatively rated based on the valence or emotional affect the stimuli incite. For example, validated positive stimuli incite a positive affective response, validated negative stimuli incite a negative affective response, and validated neutral stimuli incite little or no emotional response. Collecting such data during the calibration test provides for the assessment of the response tendencies of the panelist(s) and ‘ground-truth’ or baseline markers of a positive or negative response for comparison to the neuro-response data collected during the interaction.

Experiencing multisensory stimuli may involve movement by panelist(s), potentially resulting in extra movement artifacts that can lower the signal-to-noise ratio of the collected neuro-response data. Accordingly, the calibration test(s) in the example process of FIG. 3 are controlled, such that the movements and/or timing of actions of the panelist(s) and/or their interaction with the multisensory stimuli of the same modality as the target product are predefined or fixed. In an example, the example calibration test may begin with panelist(s) taking three deep inhales of coffee beans over a period of approximately five seconds followed by application of a neutralizer. The panelist(s) then lean forward with their arms resting on a table and relax their neck and shoulders over a period of approximately five seconds. The panelist(s) then close their eyes for the next five seconds. The panelist(s) then inhale for five seconds, and then exhale for five seconds. The panelist(s) then consider the scent over a period of approximately ten seconds and then open their eyes. This calibration test may then be repeated with other validated olfactory stimuli.

Another example calibration test involves the sensory modality of taste that begins with panelist(s) taking a sip of water over a period of approximately five seconds followed by the application of a neutralizer. The panelist(s) then lean forward and relax with their eyes closed at a table according to similar timing described above for the smell calibration test. The panelist(s) then open their mouths to receive a flavor sample over a period of approximately five seconds at which point a flavor sample is sprayed into the mouths of the panelist(s). The panelist(s) then close their mouths over a period of approximately five seconds. The panelist(s) then consider the flavor over a period of approximately ten seconds and then open their eyes. The test may then be repeated with other validated gustatory stimuli.

Another example calibration test involves the sensory modality of touch involving panelist(s) rubbing their hands together ten times over a period of approximately five seconds. The panelist(s) then place their wrists in a straight position while relaxing their arms and shoulders over a period of approximately five second. The panelist(s) then close their eyes for approximately five seconds and then put their hands down at the wrists for approximately ten seconds before putting their hands up at the wrists for approximately ten seconds. The panelist(s) then open their eyes. The calibration test may then be repeated with other validated somatosensory stimuli.

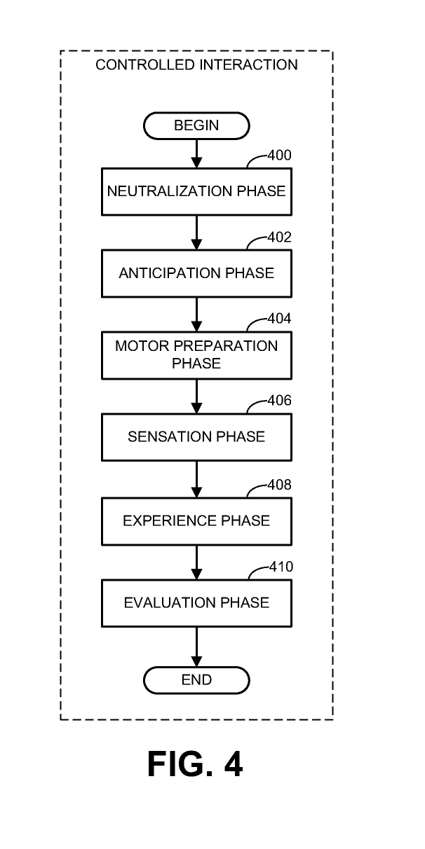

With the first neuro-response data collected, the example process of FIG. 3 continues by exposing the panelist(s) to a test subject during a controlled interaction (block 304). In the illustrated example, the test subject may be presented via any suitable means including, for example, a television, a computer, or other appropriate device. In some examples, the test subject is a physical object (e.g., a product) in which case the panelist(s) are presented with the object itself. In such examples, the interaction involves multisensory stimuli. As such, where the panelist(s) are to physically interact with the test subject (e.g., a product) the panelist(s) are likely to move. To limit extra movement artifacts creating noise in the neuro-response data collected, the interaction is controlled similarly to the example multisensory calibration tests described above. The details of controlling the interaction will be described in greater detail below in connection with FIG. 4. Also, when the test subject is a physical object, the object may be covered or otherwise concealed prior to the interaction so as to prevent panelist(s) from developing any impressions ahead of the actual controlled exposure. In some such examples, instructions of when to uncover and/or access and how to subsequently interact with the object may be presented via a test administrator or any suitable testing device.

The example process of FIG. 3 includes collecting additional neuro-response data during the interaction (block 306). As during the calibration test(s), the data may be collected via the example neuro-response data collector(s) 110). The example process determines whether the panelist(s) are to be provided with additional interactions (block 308). If the panelist(s) are to engage in additional interactions, the example process returns to block 304 to expose the panelist(s) to an additional test subject and to collect additional neuro-response data (block 306). If there are no additional interactions, the example process proceeds to block 310 where explicit response data is collected (via, for example, the explicit response data collector(s) 114).

The example process of FIG. 3 also includes analyzing the neuro-response data, the video data, and/or the explicit response data (e.g., via the data analyzer 108) to determine an impact of the test subject on the panelist(s) (block 312). Prior to analyzing the neuro-response data directly, in some examples, tagged times of interest in the video data are correlated to the neuro-response data (e.g., via the data integrator 106). Such times of interest may include the identification of extra movement physical activity and/or desired movement as described by the controlled interaction and/or during the calibration test(s). Thus, undesirable artifacts may be identified in the collected neuro-response data signals and filtered out, and relevant neuro-response data is associated with the particular activity the panelist(s) was engaged in while interacting with the test subject. With the neuro-response data properly filtered, the impact of the test subject on the panelist(s) is assessed by comparing the additional neuro-response data at any point in time throughout the interaction with the first neuro-response data indicative of the baseline tendencies of the panelist(s). In these examples, the ongoing or continual impact of the test subject is assessed (e.g., by the analyzer 108) from the beginning of the interaction on through to the end. After the neuro-response data has been analyzed, the example process of FIG. 3 ends.

FIG. 4 is a flowchart representative of an example process to define and/or implement the controlled interaction of block 304 in the example process of FIG. 3. Furthermore, the example process of FIG. 4 also may be implemented as the interaction of block 202 in the example process of FIG. 2. Neuro-response data can be affected by extra movement artifacts creating noise disrupting the signal intended to be measured. Movement of panelist(s) is of special concern when the panelist(s) are exposed to multisensory stimuli such as, for example, when the panelist(s) are interacting with a product. To account for movement, the example process of FIG. 4 defines and/or implements different phases to control the timing and progression of such a multisensory interaction to enable the collection of reliable neuro-response data and to acquire timing benchmarks for data mapping.

The example process of an interaction includes a neutralization phase (block 400). The neutralization phase provides neutral stimuli to remove any latent effects of stimuli panelist(s) may have experienced before the interaction. For example, where a test subject is a soup to be tasted (i.e., somatosensory modality), the example process of FIG. 4 defines the neutralization phase to instruct the panelist(s) to take a sip of water over a period of approximately five seconds or any other suitable time period.

The example process of FIG. 4 also defines an anticipation phase (block 402). During the anticipation phase the panelist(s) do not directly interact with the test subject with respect to the sensory modality of interest but nevertheless are exposed to the test subject. For example, if the test subject is soup and the sense of taste is being measured, the panelist(s) sit still and look at a bowl of the soup in front of them over a period of, for example, approximately five seconds. Related to the anticipation phase, the example process of FIG. 4 defines a motor preparation phase (block 404). The motor preparation phase also precedes the actual interaction with the test subject through the sensory modality of interest but involves physical movement to prepare for the interaction of interest. In the soup example, the motor preparation phase may include panelist(s) reaching forward and bring a spoon containing the soup to their mouth and then opening their mouth, which may occur over a period of, for example, approximately five seconds.

The example process of FIG. 4 also defines a sensation phase (block 406). The sensation phase involves the panelist(s) focusing on the test subject through the sensory modality of interest. For example, the panelist(s) place the spoon of soup in their mouth and place the spoon back down on the table over a period of, for example, approximately five second. The panelist(s) also hold the soup in their mouths without moving their mouths or tongues for approximately five additional seconds or any other suitable time period. The example process also defines an experience phase (block 408). The experience phase is related to the sensation phase but further involves panelist(s) completely experiencing the test subject through all relevant sensory modalities. For example, the panelist(s) move their tongue to experience the soup in their mouth and then swallow the soup over a period of, for example, approximately five seconds.

The example process of an interaction represented in FIG. 4 further defines an evaluation phase (block 410). During the evaluation phase panelist(s) are instructed to consider or contemplate their interaction with the test subject (e.g., the soup in the above example) over a period of, for example, approximately ten seconds. After the evaluation phase, the example multisensory interaction of FIG. 4 ends.

In some examples, some of the phases described in the example process of FIG. 4 may be removed, combined, and/or rearranged depending on the test subject being tested and/or the sensory modalities of interest. For example, a multisensory interaction that focuses on the modality of smell may involve panelist(s) interacting with a target product of laundry detergent. In such an example, panelist(s) sit still and look at a container of laundry detergent placed in front of them over a period of, for example, approximately five seconds (anticipation phase). The panelist(s) then reach forward and pick up the container of laundry detergent over a period of, for example, approximately five seconds (motor preparation phase). Then the panelist(s) bring the container of laundry detergent up to their nose for approximately five seconds or any suitable time period but do not sniff or inhale (sensation phase). The panelist(s) then inhale over a period of, for example, approximately five seconds and exhale over a period of, for example, approximately five seconds (experience phase). Finally, the panelist(s) set the container of laundry detergent down over a period of, for example, approximately five seconds and then consider or contemplate the scent of the detergent for approximately ten seconds (evaluation phase). The time to instruct panelist(s) to transition between each timed activity is such that the overall interaction is approximately one minute in duration.

Another example multisensory interaction that focuses on the modality of taste may involve a target product of ice cream. In such an example, panelist(s) sit still and look at a container of ice cream placed in front of them over a period of, for example, approximately five seconds (anticipation phase). The panelist(s) then reach forward and bring a spoon containing the ice cream up to their mouth over a period of, for example, approximately five seconds place the spoon of ice cream into their mouth, and set the spoon back down over a period of, for example, approximately five seconds (motor preparation phase). The panelist(s) then keep their mouths and tongues still and taste the ice cream over a period of, for example, approximately five seconds (sensation phase). The panelist(s) then slowly swirl the ice cream in their mouths over a period of, for example, approximately five seconds and then swallow the ice cream over a period of, for example, approximately five seconds (experience phase). Finally, the panelist(s) consider or contemplate the ice cream over a period of, for example, approximately ten seconds (evaluation phase). The time to instruct panelist(s) to transition between each timed activity is such that the overall interaction is approximately one minute in duration.

Another example multisensory interaction that focuses on the modality of touch may involve opening a bottle. In such an example, panelist(s) sit still and look at the bottle placed in front of them over a period of, for example, approximately five seconds, read the label on the bottle over a period of, for example, approximately five seconds, and look at the features on the bottle over a period of, for example, approximately five seconds (anticipation phase). The panelist(s) then reach forward and open the bottle over a period of, for example, approximately five seconds, place the cap down, and rest their hands on a table over a period of, for example, approximately five additional seconds (sensation/experience phase). Finally, the panelist(s) inhale over a period of, for example, approximately five seconds and then consider or contemplate the bottle over a period of, for example, approximately ten seconds (evaluation phase). The time to instruct panelist(s) to transition between each timed activity is such that the overall interaction is approximately one minute in duration.

Use of the example multisensory interaction process of FIG. 4 as the interaction process of FIG. 3 provides a complete method for collecting and calibrating neuro-response data in a controlled manner for virtually any sort of test subject. The controlled exposure to the calibration test stimuli and the test subject (e.g., by setting fixed times and specific physical activities) limits potential testing confounds. This controlled exposure also enables the aggregation of neuro-response data across multiple panelists for analysis and extrapolation to a more general population. While the above examples describe interactions that last for approximately one minute, the duration of an interaction and/or the duration of any particular activity and/or phase within the interaction may be suitably adapted according to the test subject with which the panelist(s) are to interact and/or any other research methodology consideration.

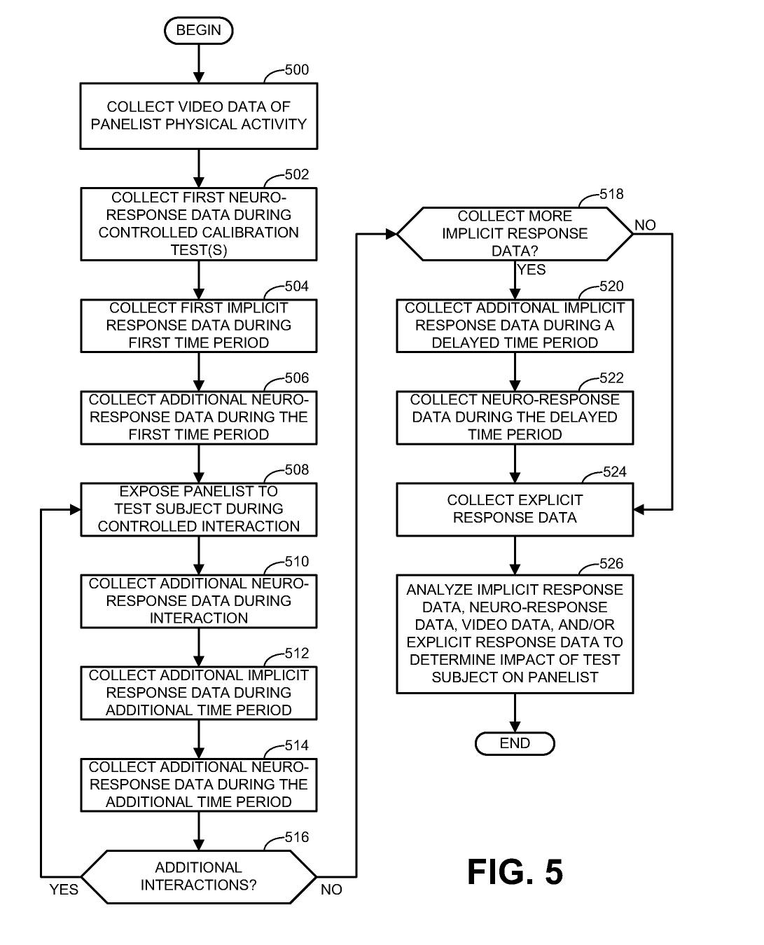

FIG. 5 is a flowchart representative of another example process that may be carried out to determine an impact of a test subject on panelist(s), and/or, more generally, to implement the example system 100 of FIG. 1. The example process of FIG. 5 combines the implicit response testing of FIG. 2 with the neuro-response testing of FIG. 3 including the controlled interaction(s) as described in FIG. 4. Combining implicit measures taken before and after an interaction with neuro-response data collected throughout the process enables the example system 100 to assess the impact and continual effects of the test subject on panelist(s) based on a more complete picture than has been previously taught in the art. Furthermore, the combined example processes enable a comprehensive analysis of interactions based on multisensory stimuli including data based on both panelist(s) viewing advertisements and/or information about the target product and panelist(s) actually experiencing a target product.

The example process of FIG. 5 includes collecting video data of the physical activity of panelist(s) (block 500) such as, for example, as described above. Furthermore, the example process includes collecting first neuro-response data during one or more calibration tests (block 502). The first neuro-response data of the illustrated example may be collected in accordance with the calibration test(s) described above in connection with the example process of FIG. 3. The example process also includes collecting first implicit response data during a first time period (block 504). The first implicit response data may be obtained through one or more suitable implicit cognitive tests (ICTs) such as those described above in connection with FIG. 2. In some examples, the process of FIG. 5 includes collecting neuro-response data during the first time period (block 506). In some such examples, the first neuro-response data may correspond to the additional neuro-response data collected concurrently with the first implicit response data during the implementation of the one or more ICTs. In other examples, the first neuro-response data is different than the additional neuro-response data collected during the one or more ICTs. The data collected in blocks 500, 502, 504, and 506 may be used to determine baseline characteristics of the panelist(s) (e.g., baseline response tendencies, baseline emotional state, implicit attitudes, sensitivities, etc.) for subsequent comparison such as, for example, as described above in connection with FIGS. 2 and 3.

The example process of FIG. 5 also includes exposing the panelist(s) to the test subject during a controlled interaction (block 508). In the illustrated example, the controlled interaction follows the structure of the example implementation of the example interaction described in connection with FIG. 4. The example process of FIG. 5 also includes collecting additional neuro-response data during the controlled interaction (block 510). After the interaction, the example process involves collecting additional implicit response data during an additional time period (block 512). Furthermore, additional neuro-response data may be collected during the additional time period (block 514). For example, the additional neuro-response data may be collected during one or more of the ICTs described herein to collect the additional implicit response data.

The example process determines whether the panelist(s) are to be exposed to additional test subject(s) during additional interactions (block 516). If the panelist(s) are to participate in additional interactions, the example process returns to block 508 to repeat the process with an additional interaction to collect additional neuro-response data (blocks 510 and 514) and implicit response data (block 512). If the panelist(s) are not to participate in additional interactions, the example process advances to determine whether additional implicit response data is to be collected (block 518). As described above, in connection with FIG. 2, additional implicit response data may be desirable to assess a long-term or residual impact of the test subject(s) on the panelist(s). Thus, if such additional implicit response data is desired, the example process implements additional ICTs to collect additional implicit response data during a delayed time period (block 520). Furthermore, additional neuro-response data may be collected during the delayed time period (block 522).

The example process of FIG. 5 further includes collecting explicit response data (block 524). Where the example process determines that additional implicit response data will not be collected (at block 518), the example process may advance directly to block 524. As described above in connection with FIGS. 2 and 3, the explicit response data may include biographic, and/or demographic information of the panelist(s) and/or subjective ratings of the panelist(s) relative to the test subject (e.g., media, a product, and/or a brand) and/or a target product and/or brand relating to the test subject and/or competing products and/or brands.

The example process also includes analyzing the collected neuro-response data, implicit response data, and/or explicit response data to determine an impact of the test subject on the panelist(s) (block 526). The data may be tagged and/or synced to the physical activities of the panelist(s) throughout the example. In addition, potential confounding artifacts in the data can be filtered out and the data may be aggregated with similar data collected from other panelist(s). After analyzing the data, the example process of FIG. 5 ends.

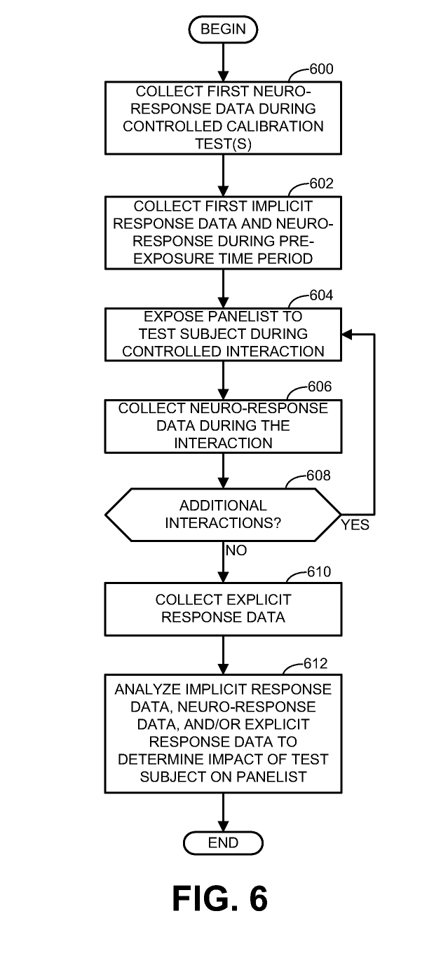

While the example process of FIG. 5 combines aspects of the example processes of FIGS. 2-4, FIGS. 6 and 7 are flowcharts representative of two other example processes that may be carried out to determine an impact of a test subject on a panelist(s), and/or, more generally, to implement the example system 100 of FIG. 1. The example process of FIG. 6 involves collecting neuro-response data and implicit response data as in the example process of FIG. 5. However in FIG. 6, only one instance of implicit response data is collected. In particular, the example process of FIG. 6 includes collecting first neuro-response data during one or more controlled calibration test(s) (block 600). The calibration test(s) may be similar to those described in connection with FIG. 3 with the neuro-response data being collected by one or more neuro-response data collector(s) (e.g., the data collector(s) 110). The collected data serves to determine baseline emotional states and/or response tendencies and/or sensitivities of the panelist(s). The example process of FIG. 6 also involves collecting first implicit response data and neuro-response data during a pre-exposure time period (block 602). The implicit response data and the neuro-response data are collected via the implicit response data collector(s) and the neuro-response data collector(s) as described above. Further, the pre-exposure time period is comparable to the first time period described above where one or more ICT was implemented. The data collected at block 602 is used to determine generic and emotional based response tendencies and response sensitivities of the panelist(s).

Similar to the example process of FIGS. 3 and 5, the example process of FIG. 6 also involves exposing panelist(s) to a test subject during a controlled interaction (block 604). In some examples, the controlled interaction is similar to the example process of FIG. 4. Additionally, during the interaction, the neuro-response data collector(s) collect additional neuro-response data (block 606). After a first interaction, the example process determines whether panelist(s) are to be exposed to additional test subjects during additional interactions (block 608). If so, the example process returns to block 604 to provide the additional interaction and to collect additional neuro-response data (block 606). When no further interactions are to be provided (block 608), the example process advances to block 610 where explicit response data is collected. The explicit response data may include any of the corresponding data described. Thus, unlike the previously described examples processes, the example process of FIG. 6 does not include implicit measures between each interaction. Or, in the case of a single interaction, the example process of FIG. 6 does not involve collecting implicit response data after the interaction. The implicit response data, the neuro-response data, and/or explicit response data are analyzed (e.g., via the data analyzer 108) to determine an impact of the impact of the test subject on the panelist(s) (block 612). While no implicit response data is collected to determine a post-exposure bias in the example of FIG. 6, the first implicit response data may be analyzed to determine a baseline implicit attitude and the neuro-response data analyzed to determine the effect(s) of the test subject on the panelist(s) throughout the one or more interaction(s) with the baseline attitude as an initial reference. After the data has been analyzed, the example process of FIG. 6 ends.

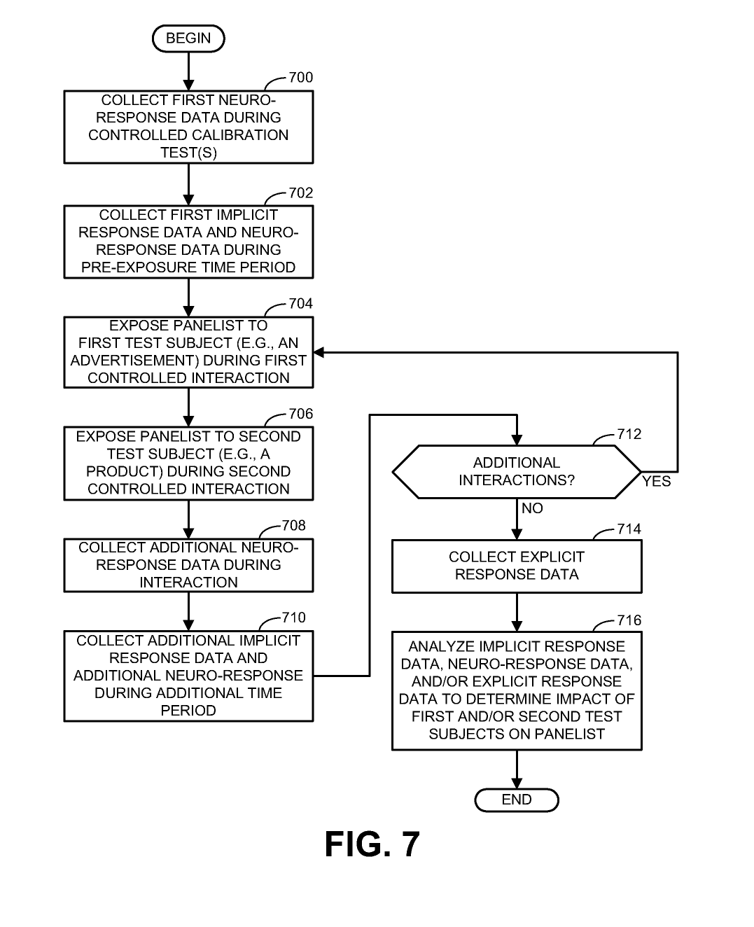

FIG. 7 is another example process to determine the impact of a test subject. In the example process of FIG. 7, multiple interactions are presented between each time period of implicit measures. More particularly, the example of FIG. 7 describes a first interaction involving an advertisement associated with a target product immediately followed by an interaction with the target product itself. However, other combinations of interactions and/or different numbers of interactions may be combined between the time periods for implicit measures. The example process of FIG. 7 begins at block 700 where first neuro-response data is collected (by, for example, one or more of the neuro-response data collector(s) 110) during one or more controlled calibration test(s) (block 700). The collected data is used to determine baseline response tendencies of the panelist(s). The example process also includes collecting first implicit response data and neuro-response data during a pre-exposure time period (block 702). The data of block 700 and/or 702 is used to determine generic and emotional based response tendencies and response sensitivities of the panelist(s).

The example process of FIG. 7 also includes exposing panelist(s) to an advertisement as a first test subject during a first controlled interaction (block 704). In the illustrated example, the advertisement is associated with a target product. The example process also provides the target product itself as a second test subject during a second controlled interaction (block 706). As the second interaction involves a product, the interaction will involve multisensory stimuli and may incorporate one or more aspect(s) of the second controlled interaction of the example interaction described in FIG. 4. During both the first and second interactions, additional neuro-response data is collected (by, for example, the neuro-response data collector(s) 110) (block 708). The example process of FIG. 7 also includes collecting additional implicit response data and additional neuro-response data during an additional time period after the interactions (block 710). The implicit response data is used to determine a post-exposure bias of the panelist(s) with respect to the target product, as described above. However, in the example of FIG. 7, the implicit response data has been influenced by two interactions instead of one. In addition, the example process includes collecting the additional neuro-response data to assess the continual impact of the test subject on the panelist(s) throughout the entire process.

The example process determines whether panelist(s) are to be exposed to additional test subject(s) during additional interactions (block 712). If the panelist(s) are to be exposed to additional test subject(s), the example process returns to block 704 to provide additional advertisements and products during the corresponding first and second interactions (block 704 and 706) and to collect corresponding additional neuro-response data (block 708). In some examples, the advertisements and/or products may be related, while in other examples they may be unrelated. The example sequence of the example process of FIG. 7 is beneficial for determining the impact of context (e.g., brand affiliation/knowledge, packaging, advertising, etc.). In some examples, the product during the first iteration and the product during the second iteration may be the same while the advertisement in either the first or second iteration relates to the product, and the advertisement in the other of the first or second iteration does not relate to the product. The related advertisement may be in the first iteration for some panelists while in the second iteration for other panelists to account for any priming effects. In this example, the impact of the related advertisement can be measured against the impact of the unrelated advertisement. In other examples, different contexts may be provided in place of the advertisements. For example, in testing the taste of soup, during one of the iterations of the example process of FIG. 7 panelist(s) are exposed to a packaging for the soup that indicates the soup is labeled as “low sodium.” In another of the iterations, the packaging may indicate that the soup is labeled as “regular.” However, during both iterations of the controlled interactions with the soup, the same soup is used. Thus, based on the differing responses of panelist(s) to the soup tasted after being exposed to the “low sodium” labeled packaging compared with the soup tasted after being exposed to the “regular” labeled packaging, the effect or impact of the packing (i.e., the test subject) may be determined.

When all iterations of interactions are complete, the example process advances to block 714, where explicit response data is collected such as, for example, as described above. In addition, the implicit response data, the neuro-response data, and/or the explicit response data is analyzed (by, for example, the data analyzer 108) to determine an impact of the first and/or second test subjects on the panelist(s) (block 716). In the illustrated example, however, a calculated pre-exposure bias compared with a calculated post-exposure bias corresponds to the combined impact of each advertisement and corresponding product. Such an example process is useful in analyzing the impact of context (e.g., advertising, packaging, branding, etc.) on the preference(s) of panelist(s). Furthermore, where multiple sets of interactions are included, the preference(s) of panelist(s) for one product with respect to a second product may also be assessed. After the data has been analyzed, the example process of FIG. 7 ends.

FIG. 8 is an example subjective rating questionnaire 800 that may be used in any of the example processes of FIGS. 2-7 and/or, more generally, used to collect the survey data 140 of FIG. 1. In the illustrated example, the questionnaire 800 includes one or more general product preference questions 802, one or more preference basis questions 804, one or more product ratings questions 806 that ask panelist(s) to rate target products based on any number of attributes 808 on a scale 810, and/or product comparison questions 812. The questionnaire 800 of FIG. 8 is by way of example only and any suitable questions may be posed to panelist(s) to collect any desired explicit response data.

FIG. 9 is a schematic illustration of an example processor platform 900 that may be used and/or programmed to execute any of the example machine readable instructions of FIGS. 2-7 to implement the example system 100 of FIG. 1. The processor platform 900 of the instant example includes a processor 912. For example, the processor 912 can be implemented by one or more microprocessors or controllers from any desired family or manufacturer.

The processor 912 includes a local memory 913 (e.g., a cache) and is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914 and 916 is controlled by a memory controller.

The computer 900 also includes an interface circuit 920. The interface circuit 920 may be implemented by any type of interface standard, such as an Ethernet interface, a universal serial bus (USB), and/or a PCI express interface. One or more input devices 922 are connected to the interface circuit 920. The input device(s) 922 permit a user to enter data and commands into the processor 912. The input device(s) can be implemented by, for example, a keyboard, a mouse, a touchscreen, a track-pad, a trackball, isopoint and/or a voice recognition system. One or more output devices 924 are also connected to the interface circuit 920. The output devices 924 can be implemented, for example, by display devices (e.g., a liquid crystal display, a cathode ray tube display (CRT), a printer and/or speakers). The interface circuit 920, thus, typically includes a graphics driver card.

The interface circuit 920 also includes a communication device such as a modem or network interface card to facilitate exchange of data with external computers via a network 926 (e.g., an Ethernet connection, a digital subscriber line (DSL), a telephone line, coaxial cable, a cellular telephone system, etc.).

The processor platform 900 also includes one or more mass storage devices 928 for storing software and data. Examples of such mass storage devices 928 include floppy disk drives, hard drive disks, compact disk drives and digital versatile disk (DVD) drives.

Coded instructions 932 to implement the example processes of FIGS. 2-7 may be stored in the mass storage device 928, in the volatile memory 914, in the non-volatile memory 916, and/or on a removable storage medium such as a CD or DVD.

Although certain example methods, apparatus and articles of manufacture have been described herein, the scope of coverage of this patent is not limited thereto. Such examples are intended to be non-limiting illustrative examples. On the contrary, this patent covers all methods, apparatus and articles of manufacture fairly falling within the scope of the appended claims either literally or under the doctrine of equivalents.

1. A method, comprising:
obtaining first implicit response data from a panelist at a first time period before an interaction during which the panelist is exposed to a test subject;
obtaining second implicit response data from the panelist at a second time period after the interaction; and
determining an impact of the test subject on the panelist based on the first and second implicit response data.

2. The method of claim 1, wherein the test subject comprises one or more of media, content, an advertisement, entertainment, a product, a product package, or a brand.

3. The method of claim 1, further comprising obtaining third implicit response data from the panelist at a third time period after the interaction, the third time period being later than the second time period.

4. (canceled)

5. The method of claim 3, further comprising:
determining a first bias of the panelist before the interaction based on the first implicit response data;
determining a second bias of the panelist based on the second implicit response data; and
determining a direct impact of the test subject based on the first bias and the second bias.

6. The method of claim 5, further comprising:
determining a third bias of the panelist based on the third implicit response data; and
determining a residual impact of the test subject based on the first bias, the second bias, and the third bias.

7. The method of claim 1, wherein one or more of the first implicit response data or the second implicit response data is gathered while the panelist participates in implicit cognitive tasks.

8-11. (canceled)

12. The method of claim 1, further comprising:
obtaining first neuro-response data from the panelist during the first time period before the interaction;
obtaining second neuro-response data from the panelist during the interaction; and
determining the impact of the test subject on the panelist based on the first neuro-response data and the second neuro-response data.

13. (canceled)

14. The method of claim 12, wherein the interaction comprises multisensory stimuli involving more than one sensory modality.

15. The method of claim 14, wherein the interaction includes three or more of a neutralization phase, an anticipation phase, a motor preparation phase, a sensation phase, an experience phase, or an evaluation phase.

16. The method of claim 15, wherein each phase is associated with one or more panelist actions having a fixed duration and a fixed sequence to enable aggregation of the second neuro-response data gathered during the phase with third neuro-response data gathered from a second panelist during a corresponding phase.

17. The method of claim 14, wherein the sensory modality comprises at least one of an auditory, a visual, a somatosensory, a gustatory, or an olfactory sensory modality.

18. The method of claim 12, wherein the first neuro-response data is gathered while the panelist interacts with calibration stimuli to determine at least one of a baseline response tendency, a baseline response sensitivity, or a preference marker associated with the panelist.

19. (canceled)

20. The method of claim 12, wherein determining the impact of the test subject on the panelist comprises determining at least one of a preference of the panelist for a product associated with the test subject, a change in the preference for a product associated with the test subject, the preference for the product relative to another product, or an effect of a context on the change in the preference, the context comprising at least one of an advertisement, a packaging, or brand affiliation of the panelist associated with the product.

21-22. (canceled)

23. A system comprising:
an input interface to receive first implicit response data from a panelist at a first time period before an interaction during which the panelist is exposed to a test subject and to receive second implicit response data from the panelist at a second time period after the interaction; and
a data analyzer to analyze the first and second implicit response data to determine an impact of the test subject on the panelist.

24-33. (canceled)

34. The system of claim 23, wherein the input interface is to receive first neuro-response data from a panelist during the first time period before the interaction and second neuro-response data from a panelist during the interaction, and the data analyzer is to determine the impact of the test subject on the panelist based on the first neuro-response data and the second neuro-response data

35. The system of claim 34, wherein the data analyzer is to determine an ongoing impact of the test subject on the panelist based on the second neuro-response data, wherein the second neuro-response data is to be obtained from the panelist throughout the first time period, the interaction, and the second time period.

36-38. (canceled)

39. The method of claim 34, wherein the interaction comprises multisensory stimuli involving more than one sensory modality.

40-44. (canceled)

45. A tangible machine readable storage medium comprising instructions which, when executed, cause a machine to at least:
obtain first implicit response data from a panelist at a first time period before an interaction during which the panelist is exposed to a test subject;
obtain second implicit response data from the panelist at a second time period after the interaction; and
determine an impact of the test subject on the panelist based on the first and second implicit response data.

46. (canceled)

47. A tangible article of manufacturing as described in claim 46, wherein the machine readable instructions, when executed, further cause the machine to:
determine a first bias of the panelist before the interaction based on the first implicit response data;
determine a second bias of the panelist based on the second implicit response data; and
determine a direct impact of the test subject based on the first bias and the second bias.

48-50. (canceled)

51. A tangible article of manufacturing as described in claim 45, wherein the machine readable instructions, when executed, further cause the machine to:
obtain first neuro-response data from the panelist during the first time period before the interaction;
obtain second neuro-response data from the panelist during the interaction; and
determine the impact of the test subject on the panelist based on the first neuro-response data and the second neuro-response data.

52-54. (canceled)
